(19) United States
(12) Patent Application Publication
(10) Pub. No.: US 2007/0065676 A1
(43) Pub. Date: Mar. 22, 2007

(54) Inert processing of oxide ceramic matrix composites and oxidation sensitive ceramic materials and intermediate structures and articles incorporating same

(76) Inventors: Carlos F. Bacalski, San Diego, CA (US); Belinda A. Fischer, Virginia Beach, VA (US); Richard Plunkett, San Diego, CA (US)

Correspondence Address: TRASKBRITT, P.C./ ALLIANT TECH SYSTEMS, P.O. BOX 2550, SALT LAKE CITY, UT, 84110, US

(21) Appl. No.: 11/229,346

(22) Filed: Sep. 16, 2005

(51) Int. Cl. B28B 3/00; B32B 19/00; B28B 1/00

(52) U.S. Cl. 428/688; 264/642

(57) ABSTRACT

A method of forming a structurally integrated component. The method comprises providing a first ceramic material comprising an oxidation sensitive ceramic material and providing a second ceramic material comprising an uncured, oxide ceramic matrix composite. The first ceramic material may be a carbon-based ceramic material selected from the group consisting of carbon fibers, carbon whiskers, carbon powder, graphite, silicon carbide, silicon oxycarbide, and mixtures thereof. The second ceramic material may comprise an inorganic oxide fiber reinforcement impregnated with an alumina matrix or an aluminosilicate matrix. The second ceramic material and the first ceramic material are contacted to form an uncured, structurally integrated precursor component, which is co-cured. The co-cured, structurally integrated precursor component is then co-fired in an inert atmosphere to bond the first ceramic material and the second ceramic material. A co-cured, structurally integrated precursor component and a structurally integrated component are also disclosed.

### STATEMENT REGARDING FEDERALLY SPONSORED RESEARCH

The United States Government has a paid-up license in this invention and the right in limited circumstances to require the patent owner to license others on reasonable terms as provided for by the terms of Contract No. DAAH23-00-C-A001 awarded by the Department of Defense.

### FIELD OF THE INVENTION

The present invention relates to a method of joining dissimilar ceramic materials without affecting desirable properties of the ceramic materials. More specifically, the present invention relates to joining an oxide ceramic matrix composite (“CMC”) and an oxidation sensitive ceramic material.

### BACKGROUND OF THE INVENTION

Ceramic materials are known to have good hardness and resistance to heat, abrasion, and corrosion. Therefore, ceramic materials are commonly used in high temperature environments, such as in high speed cutting and grinding tools, furnace heating elements and igniters, or thermal barrier coatings for metals. Ceramic matrix composites (“CMCs”) are generally categorized into oxide CMC materials and nonoxide CMC materials, which two categories of materials have different mechanical, physical, and electrical properties. To provide desirable mechanical, physical, and electrical properties, combinations of ceramic materials have also been used. Dissimilar ceramic materials are joined together to produce a complex ceramic structure that has a desirable combination of mechanical, physical, and electrical properties for use in a specific high-temperature environment. For instance, the dissimilar ceramic materials are adhesively joined using a ceramic adhesive. However, the ceramic adhesive potentially limits the size and configuration of the complex ceramic structure that is capable of being produced and also potentially limits the temperature at which the complex ceramic structure is able to be used. In addition, the strength of the joint between the dissimilar ceramic materials is typically low. Alternatively, the dissimilar ceramic materials are molded into an integral component. However, with molding, only small, noncomplex shapes may be formed.

Ceramic materials are also joined by curing or firing the dissimilar ceramic materials, such as in an oxidizing atmosphere or environment (i.e., air). However, this technique is ineffective if one of the ceramic materials is sensitive to oxidation, because the desirable properties of the ceramic material are negatively affected by the oxidizing atmosphere. It is also possible to join the dissimilar ceramic materials by firing the ceramic material that is sensitive to oxidation in an inert atmosphere and firing the other ceramic material in an oxidizing atmosphere. The ceramic materials, which are fully processed or cured, are then joined with the ceramic adhesive. However, using the ceramic adhesive in this situation produces the same disadvantages as discussed above.

U.S. Pat. No. 6,648,597 to Widrig et al. discloses forming a vane component for a gas turbine. The vane component includes an airfoil member formed from an oxide or nonoxide CMC material and a platform member formed from an oxide or nonoxide CMC material. Each of the airfoil member and the platform member are formed into a green body state and are bonded to form an integral vane component. The bond between the airfoil member and the platform member is an adhesive bond or a sinter bond produced by firing the airfoil member and the platform member. The bond between the airfoil member and the platform member is further reinforced with a mechanical fastener.

### BRIEF SUMMARY OF THE INVENTION

The present invention relates to a method of forming a structurally integrated component. The method comprises providing a first ceramic material comprising an oxidation sensitive ceramic material and providing a second ceramic material comprising an uncured, oxide ceramic matrix composite. The first ceramic material may include oxide fibers and a carbon-based ceramic material selected from the group consisting of carbon fibers, carbon whiskers, carbon powder, graphite, silicon carbide, silicon oxycarbide, and mixtures thereof. The first ceramic material may be a carbon-based, high-temperature, radar attenuating material. The first ceramic material may further comprise at least one water-soluble organic ingredient selected from the group consisting of gum, vinyl alcohol, glycol, and mixtures thereof, such as methyl cellulose, acacia gum, propylene glycol, ethylene glycol, polyvinyl alcohol, and mixtures thereof. The second ceramic material may comprise an inorganic oxide fiber reinforcement impregnated with an alumina matrix or an aluminosilicate matrix. The inorganic oxide fiber reinforcement may be alumina, a mixture of alumina and silicon dioxide, or a mixture of alumina, silicon dioxide, and boria.

The second ceramic material and the first ceramic material are contacted to form an uncured, structurally integrated precursor component, which is co-cured to form a co-cured, structurally integrated precursor component. The uncured, structurally integrated precursor component may be co-cured by exposing the uncured, structurally integrated precursor component to a temperature sufficient to cure the second ceramic material, such as a temperature ranging from approximately 75° C. to approximately 200° C. Co-curing the uncured, structurally integrated precursor component may cause the second ceramic material to dehydrate and consolidate around the first ceramic material.

The co-cured, structurally integrated precursor component is then co-fired in an inert environment by exposing the co-cured, structurally integrated precursor component to a temperature sufficient to bond the first ceramic material and the second ceramic material, such as a temperature ranging from approximately 900° C. to approximately 1200° C. The co-cured, structurally integrated precursor component may be co-fired in an inert atmosphere selected from the group consisting of nitrogen, argon, helium, and mixtures thereof. By co-firing the co-cured, structurally integrated precursor component, the first ceramic material and the second ceramic material may be bonded. The co-firing may also preserve electrical properties of the first ceramic material and mechanical and physical properties of the second ceramic material.

The present invention also relates to a co-cured, structurally integrated precursor component that comprises a first ceramic component and a second ceramic component co-cured to the first ceramic component. The first ceramic component and the second ceramic component are formed from the same materials as described above.

The present invention also relates to a structurally integrated component that comprises a first ceramic component and a second ceramic component bonded to the first ceramic component. The first ceramic component and the second ceramic component are formed from the materials described above. In the structurally integrated component, electrical properties of the first ceramic material and mechanical, physical, and electrical properties of the second ceramic material are substantially preserved.

### BRIEF DESCRIPTION OF THE SEVERAL VIEWS OF THE DRAWINGS

While the specification concludes with claims particularly pointing out and distinctly claiming that which is regarded as the present invention, the advantages of this invention may be more readily ascertained from the following description of the invention when read in conjunction with the accompanying drawings in which:

FIG. 1 is a schematic illustration of a co-cured, structurally integrated precursor component according to the present invention;

FIG. 2 is a schematic illustration of a structurally integrated component according to the present invention; and

FIGS. 3 and 4 are plots of dielectric properties (e′ and e″, respectively) versus frequency for structurally integrated components processed under various conditions.

### DETAILED DESCRIPTION OF THE INVENTION

A method of forming a structurally integrated component from dissimilar ceramic materials is disclosed. Each of the dissimilar ceramic materials may have different mechanical, physical, or electrical properties. By using the dissimilar ceramic materials, the structurally integrated component has optimized mechanical, physical, or electrical properties for use in a high-temperature environment. The dissimilar ceramic materials may include an oxide CMC material and a ceramic material that is sensitive to oxidation. The oxide CMC material and the oxidation sensitive ceramic material may form a material system. The oxide CMC material and the oxidation sensitive ceramic material may be joined in an inert atmosphere to produce the structurally integrated component without affecting selected, desirable mechanical, physical, or electrical properties of each of the dissimilar ceramic materials.

Oxide CMC materials are known in the art and may include a matrix and a fiber reinforcement. The oxide CMC material may provide mechanical strength and structure to the structurally integrated component. The matrix may be a sol-gel derived alumina or a sol-gel derived silica combined with an oxide filler powder. The alumina sol may include, but is not limited to, aluminum hydroxylchloride, aluminum chloride hexahydrate, alpha aluminum monohydrate, aluminum oxide hydroxide, aluminum hydroxide, aluminum acetate, or mixtures thereof. The matrix may account for from approximately 25 volume percent to approximately 50 volume percent of a total volume of the oxide CMC material. In one embodiment, the matrix is an alumina or aluminosilicate matrix.

The fiber reinforcement may be formed from an inorganic oxide, such as alumina (“Al₂O₃”), a mixture of Al₂O₃ and silicon dioxide (“SiO₂”), or a mixture of Al₂O₃, SiO₂, and boria (“B₂O₃”). Examples of commercially available, fiber reinforcements include, but are not limited to, Nextel® 312, Nextel® 550, Nextel® 610, or Nextel® 720, in which the Al₂O₃, SiO₂, and B₂O₃ are present in varying amounts. In one embodiment, the fiber reinforcement is Nextel® 312 or Nextel® 720. The Nextel® products are available from 3M Corp. (St. Paul, Minn.). Nextel® 312 is a refractory aluminoborosilicate and includes Al₂O₃, SiO₂, and B₂O₃, Nextel® 550 is a refractory aluminosilica and includes Al₂O₃ and SiO₂, Nextel® 610 is a refractory alumina and includes α-Al₂O₃, and Nextel® 720 is a refractory aluminosilica and includes α-Al₂O₃ and SiO₂. Each of these Nextel® products has a different maximum use temperature and may degrade at a temperature above its respective maximum use temperature. Therefore, the fiber reinforcement to be used in the oxide CMC material may be selected based on a maximum temperature used in processing the oxide CMC material and a maximum temperature to which the oxide CMC material is exposed during use. The fiber reinforcement may provide tensile strength and toughness to the oxide CMC material. The fiber reinforcement may be present in the oxide CMC in a range of from approximately 30 volume percent to approximately 50 volume percent of the total volume of the oxide CMC material.

Oxide CMC materials with these ingredients are commercially available, such as from COI Ceramics, Inc. (San Diego, Calif.). In one embodiment, the oxide CMC material includes an aluminosilicate oxide matrix and Nextel® 312 as the fiber reinforcement and is available from COI Ceramics, Inc. under the product name of AS/N312HT-1. The oxide CMC material may optionally include at least one water-soluble organic ingredient, such as a gum, vinyl alcohol, glycol, or mixtures thereof. The water-soluble organic ingredient may include, but is not limited to, methyl cellulose, acacia gum, propylene glycol, ethylene glycol, polyvinyl alcohol, or mixtures thereof.

The fiber reinforcement may be formed into a fabric, as known in the art, or may be commercially available as a fabric. For instance, the Nextel® products are commercially available from 3M Corp. as fabrics. A precursor to the matrix may be provided as a liquid at room temperature, either as a solution or as a slurry of the matrix in an organic or inorganic solvent. If the matrix precursor is a solid at room temperature, the matrix precursor may be melted into a liquid form by heating the matrix precursor to a temperature that is greater than its melting point but less than its cure temperature. The matrix precursor may be impregnated into the fiber reinforcement to form a so-called “prepreg.” The fiber reinforcement may be immersed in the matrix precursor or may be sprayed with the matrix precursor to achieve a uniform distribution of the matrix precursor in the fiber reinforcement. The matrix precursor may be impregnated into the fiber reinforcement using a wet lay-up technique, a prepreg fabrication technique, or a filament winding technique, all of which are known in the art. Excess organic solvent may be removed from the prepreg, such as by heat or vacuum, or the prepreg may be cooled to a temperature below the melting point of the matrix precursor. The resulting prepreg of the oxide CMC material may be drapeable and slightly tacky.

The oxide CMC material may be stably stored in a substantially uncured form until ready for use. For instance, the oxide CMC material may be maintained under temperature and pressure conditions sufficient to prevent the oxide CMC material from prematurely curing. As such, the oxide CMC material is not fully processed before co-firing with the oxidation sensitive ceramic material to produce the structurally integrated component. As described below, the uncured oxide CMC material may be formed into a desired shape by laying-up or casting the oxide CMC material onto the oxidation sensitive ceramic material, forming an oxide CMC component. Alternatively, the oxide CMC material may be formed into the oxide CMC component that has a desired three dimensional shape by conventional tooling and fabrication techniques. For instance, the fiber reinforcement may be formed into the desired three dimensional shape and impregnated with the matrix. The oxide CMC component may be formed from a single piece of the oxide CMC material or from multiple pieces of the oxide CMC material that are joined or bonded together. For instance, multiple plies of the oxide CMC material may be stacked on top of one another and laminated, as known in the art, to form a laminate.

The oxidation sensitive ceramic material may be a material whose mechanical, physical, or electrical properties are negatively affected by oxidation. For the sake of example only, the oxidation sensitive ceramic material may be a carbon-based particulate or powder, such as carbon fibers, carbon whiskers, carbon powder, graphite, silicon carbide, silicon oxycarbide, or mixtures thereof. Other types of ceramic materials, such as silicon nitride, titanium diboride, and iron silicide, are known to be sensitive to oxidation and may be used as the oxidation sensitive ceramic material. The oxidation sensitive ceramic material may be a carbon-based ceramic material that absorbs energy, such as a high-temperature, radar attenuating material. As used herein, the term “radar attenuating material” refers to a material that is absorbent of radio frequency energy over a range of from approximately 1 GHz to approximately 50 GHz. The radar attenuating material may comprise oxide fibers that account for from approximately 30% by weight (“wt %”) of a total weight of the radar attenuating material to approximately 99 wt % of the total weight of the radar attenuating material. The oxide fibers may include, but are not limited to, alumina, silica, aluminosilicate, aluminoborosilicate, or mixtures thereof. The radar attenuating material may also include oxidation sensitive fibers or powders that account for from approximately 1 wt % of the total weight of the radar attenuating material to approximately 70 wt % of the total weight of the radar attenuating material. The radar attenuating material may optionally include from approximately 0.1 wt % of the total weight of the radar attenuating material to approximately 5 wt % of the total weight of the radar attenuating material of at least one water-soluble organic ingredient. The water-soluble organic ingredient may be a gum, vinyl alcohol, glycol, or mixtures thereof. For the sake of example only, the water-soluble organic ingredient may include, but is not limited to, methyl cellulose, acacia gum, propylene glycol, ethylene glycol, polyvinyl alcohol, or mixtures thereof. When the high-temperature, radar attenuating material is exposed to an oxidizing atmosphere, the carbon is volatilized, which negatively affects the electrical properties of this material. In one embodiment, the oxidation sensitive ceramic material is a carbon-based, high-temperature, radar attenuating material.

The oxidation sensitive ceramic material may be formed into a desired shape by conventional tooling and fabrication techniques, forming an oxidation sensitive ceramic component. The oxidation sensitive ceramic component may be fully processed before the oxidation sensitive ceramic component is joined with the oxide CMC material. In other words, the oxidation sensitive ceramic component may be substantially cured in that the oxidation sensitive ceramic component may have been exposed to a high processing temperature, such as a temperature used to cure the oxidation sensitive ceramic material. The oxidation sensitive ceramic component may be formed from a single piece or multiple pieces of the oxidation sensitive ceramic material. For instance, multiple plies of the oxidation sensitive ceramic material may be stacked on top of one another and laminated to form a laminate.

While the specification and the Examples herein describe using one oxide CMC component and one oxidation sensitive ceramic component, the structurally integrated component may include one or more oxide CMC components in combination with one or more oxidation sensitive ceramic components.

To form the structurally integrated component, the oxide CMC component may be placed in contact with the oxidation sensitive ceramic component to form an uncured, structurally integrated precursor component. A surface of the oxide CMC component may be placed in contact with a surface of the oxidation sensitive ceramic component. The oxide CMC component may be cast or laid-up on a sintered block of the oxidation sensitive ceramic component. As such, the oxidation sensitive ceramic component may function as a mandrel for the lay-up of the oxide CMC component. Alternatively, if the uncured oxide CMC material is sufficiently rigid and self-supporting, the oxide CMC component having a three dimensional shape and the oxidation sensitive ceramic component may be placed in contact.

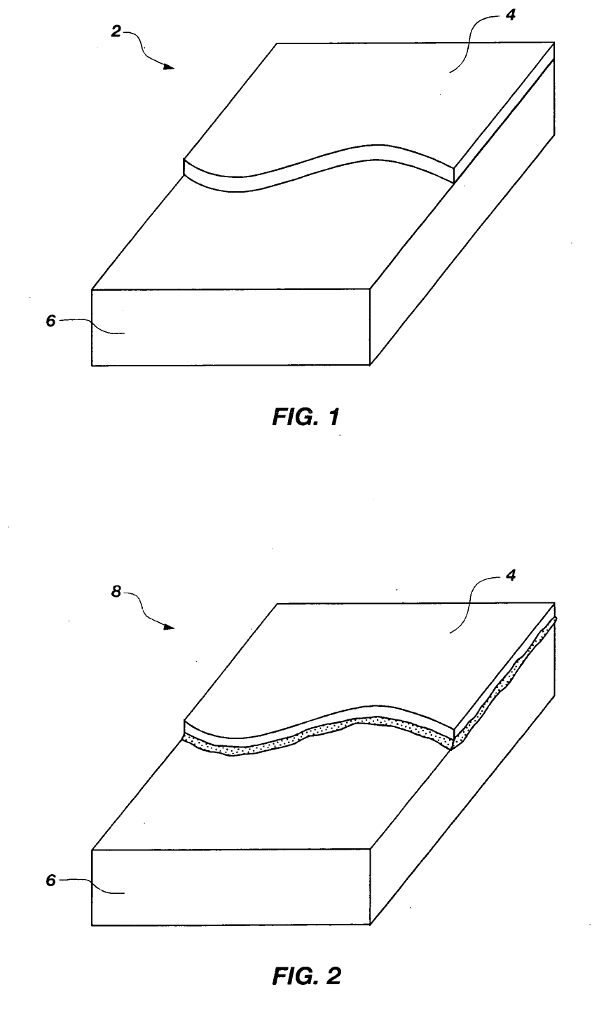

The uncured, structurally integrated precursor component may then be co-cured. As used herein, the term “co-cured,” and other verb forms thereof, refers to curing the uncured, structurally integrated precursor component while the oxide CMC component and the oxidation sensitive ceramic component are in contact with one another. The uncured, structurally integrated precursor component may be exposed to heat of a sufficient temperature and for a sufficient amount of time to cure the oxide CMC component and form a co-cured, structurally integrated precursor component. As shown in FIG. 1, the co-cured, structurally integrated precursor component 2 may include the oxide CMC component 4 and the oxidation sensitive ceramic component 6. The cure temperature may be sufficient to cure the oxide CMC component 4. However, this cure temperature may be lower than a temperature ultimately used to co-fire the co-cured, structurally integrated precursor component 2. The cure temperature and the cure time may vary depending on the oxide CMC material that is used in the structurally integrated component. The cure temperature may be less than approximately 200° C., such as ranging from approximately 75° C. to approximately 200° C. The cure time may be greater than approximately twelve hours. The uncured, structurally integrated precursor component may be co-cured in an autoclave under an inert atmosphere or an oxidizing atmosphere. The inert atmosphere may be produced using an inert gas, such as nitrogen, argon, helium, or mixtures thereof, which is introduced into the autoclave. During the co-curing, the oxide CMC component 4 may dehydrate and consolidate around the oxidation sensitive ceramic component 6. Bonding occurs between the oxide CMC component 4 and the oxidation sensitive ceramic component 6 as the matrix penetrates into the oxidation sensitive ceramic component 6, gels, and dehydrates, forming a noncrystalline, preceramic solid. However, substantially no crosslinking may occur between the oxide CMC component 4 and the oxidation sensitive ceramic component 6.

After cooling to room temperature, the co-cured, structurally integrated precursor component 2 may be co-fired in an inert atmosphere to produce the structurally integrated component 8, as shown in FIG. 2. As used herein, the term “co-fired,” and other verb forms thereof, refers to firing the co-cured, structurally integrated precursor component 2 while the oxide CMC component 4 and the oxidation sensitive ceramic component 6 are in contact with one another. The co-cured, structurally integrated precursor component 2 may be co-fired in a furnace that is capable of providing the inert atmosphere. The inert atmosphere may be produced using an inert gas, such as nitrogen, argon, helium, or mixtures thereof, which is introduced into the furnace.

The oxide CMC component 4 and the oxidation sensitive ceramic component 6 may be co-fired at a temperature sufficient to pyrolyze the oxide CMC component 4 and the oxidation sensitive ceramic component 6. The heat may form bonds between the oxide CMC component 4 and the oxidation sensitive ceramic component 6, densifying and sintering the ceramic materials. As such, co-firing the co-cured, structurally integrated precursor component 2 may be used to intimately join the dissimilar ceramic materials. In addition, since the co-firing occurs in the inert atmosphere, oxidation of the oxidation sensitive ceramic material may be prevented or reduced. Depending on the materials used in the oxide CMC component 4 and the oxidation sensitive ceramic component 6, the firing temperature may be greater than approximately 900° C., such as from approximately 900° C. to approximately 1200° C. In one embodiment, where the oxide CMC material includes an aluminosilicate matrix and Nextel® 312 and the oxidation sensitive ceramic material is a high-temperature, radar attenuating material, the firing temperature is approximately 982° C. If the firing temperature is too low, sufficient bonding may not occur between the oxide CMC component 4 and the oxidation sensitive ceramic component 6 to intimately join the ceramic materials. If the firing temperature is too high, the fiber reinforcement of the oxide CMC component 4 in the structurally integrated component 8 may be negatively affected. The co-cured, structurally integrated precursor component 2 may be heated to the firing temperature in a stepwise or linear manner. The ceramic materials may be co-fired for a sufficient amount of time to form the bonds between the oxide CMC component 4 and the oxidation sensitive ceramic component 6. For instance, the ceramic materials may be co-fired for from approximately 1 hour to approximately 5 hours, such as from approximately 3 hours to approximately 5 hours. The co-cured, structurally integrated precursor component 2 may be maintained at the firing temperature for an amount of time sufficient to substantially completely co-fire the oxide CMC component 4 and the oxidation sensitive ceramic component 6.

During the co-firing, any water-soluble organic ingredient that is optionally present in the oxide CMC component 4, such as polyvinyl alcohol, may decompose. When the co-cured, structurally integrated precursor component 2 is fired in an oxidizing atmosphere, the water-soluble organic ingredients may oxidize and volatilize. However, when the co-cured, structurally integrated precursor component 2 is co-fired in the inert atmosphere, the water-soluble organic ingredient may produce a carbonaceous char, which remains in the oxide CMC component 4. The carbonaceous char provides a gray color to the oxide CMC component 4. However, the carbonaceous char may not negatively affect the electrical properties of the oxide CMC component 4.

By co-curing and co-firing the oxide CMC component 4 and the oxidation sensitive ceramic component 6, the resulting structurally integrated component 8 may have a more complex shape and a larger size. In addition, the oxide CMC component 4 and the oxidation sensitive ceramic component 6 may be joined by a more reliable bond. Furthermore, the desirable properties of each of the ceramic materials may be preserved. For instance, if the oxidation sensitive ceramic material is the high-temperature, radar attenuating material, the electrical properties of this material may be preserved after co-firing the high-temperature, radar attenuating material with the oxide CMC component 4. In addition, the mechanical and physical properties of the oxide CMC component 4 may be maintained. In contrast, if these dissimilar ceramic materials were to be processed in an oxidizing atmosphere, the electrical properties of the high-temperature, radar attenuating material and the mechanical and physical properties of the oxide CMC material may be negatively affected. The structurally integrated component 8, which is substantially completely co-fired, may be cooled to room temperature.

The structurally integrated component 8 may be subjected to post-processing techniques, such as machining, to form the structurally integrated component 8 into a desired shape for use in a high-temperature environment. The machined, structurally integrated component may be used in manned or unmanned vehicles including, but not limited to, boats, planes, and land-based vehicles. The structurally integrated component 8 may be used on virtually any static surface that is to be exposed to a hot gas path in use. For the sake of example only, the structurally integrated component 8 may be used as a combustor liner, transition duct, static airfoil and platform (vane), or seal. Aerospace applications for the structurally integrated component 8 include, but are not limited to, aircraft hot gas (engine exhaust) impinged structures and surfaces, thermal protection systems (“TPS”) for aerospace vehicles (hypersonic or re-entry protection), and stiff, lightweight panels or structures for space systems, such as satellites, vehicles, or stations. The structurally integrated component 8 may also be used in high speed cutting and grinding tools, furnace heating elements and igniters, or thermal barrier coatings. The machined, structurally integrated component may be used in the high-temperature environment by attaching the structurally integrated component to a surface of the manned or unmanned vehicle, as known in the art.

For instance, if the oxidation sensitive ceramic material is a high-temperature, radar attenuating material, the structurally integrated component may be used in a high-temperature environment where radar suppression is desirable, such as in a low signature oxide exhaust system. The oxidation sensitive ceramic material may provide radar absorbing properties to the structurally integrated component while the oxide CMC material may provide mechanical strength and structure to the structurally integrated component.

A similar process may be used to form the structurally integrated component from a nonoxide CMC material and the oxidation sensitive ceramic material. Nonoxide CMC materials are known in the art. For instance, the nonoxide CMC material and the oxidation sensitive ceramic material may be co-cured and co-fired in the inert atmosphere, as previous described, to form the structurally integrated component.

The following examples serve to explain embodiments of the present invention in more detail. These examples are not to be construed as being exhaustive or exclusive as to the scope of this invention.

### EXAMPLES

### Example 1

### Curing of a Laminate Formed from AS/N312HT-1

A prepreg formed from AS/N312HT-1 (available from COI Ceramics, Inc.) was laid-up to form a laminate. The prepreg was four square feet in size and was prepared from fresh slurry according to the manufacturer's directions. The laminate of the prepreg was cut into nine, 4″×4″ stacks. To cure the AS/N312HT-1 prepreg, the laminate was placed in an autoclave. Nitrogen was flowed into the autoclave at an inlet pressure of 10 psi and an inlet flow rate of 10 cubic feet per hour at standard conditions (“SCFH”). A pressure of approximately 60 PSI was applied to the autoclave. The temperature in the autoclave was ramped from approximately 75° C. to approximately 200° C. at a maximum of 0.04° C./minute. The temperature was maintained at approximately 200° C. for approximately 12 hours to cure the laminate. The cured laminate was removed from the autoclave and allowed to cool to room temperature.

### Example 2

### Firing of the Cured Laminate Using an Inert Firing Cycle

One of the pieces of the laminate (#1) was placed in an inert atmosphere furnace for firing. The inert atmosphere furnace was evacuated until the rate of pressure decrease slowed. When a pressure of 175 mTorr was achieved, the inert atmosphere furnace was purged with nitrogen. The evacuation and nitrogen purge were repeated. The temperature in the inert atmosphere furnace was increased to 982° C. The temperature was maintained for approximately 3 hours and then the temperature in the inert atmosphere furnace was decreased to approximately 200° C. After the inert atmosphere furnace automatically evacuated and purged twice, the laminate was cooled to room temperature in the inert atmosphere furnace.

### Example 3

### Firing of the Cured Laminate Using a Modified Ambient/Inert Firing Cycle

One of the pieces of the laminate (#2) was placed in an ambient atmosphere furnace for firing. The temperature in the ambient atmosphere furnace was increased to approximately 475° C. The laminate was then placed in an inert atmosphere furnace, which was evacuated. When a pressure of 175 mTorr was achieved, the inert atmosphere furnace was purged with nitrogen. The evacuation and nitrogen purge were repeated. The temperature in the inert atmosphere furnace was increased to approximately 982° C. The temperature was maintained for approximately 3 hours and then the temperature in the inert atmosphere furnace was decreased to approximately 200° C. The laminate was removed from the inert atmosphere furnace and allowed to cool to room temperature.

### Example 4

### Firing of the Cured Laminate Using an Ambient Firing Cycle

One of the pieces of the laminate (#3) was placed in an ambient atmosphere furnace for firing. The temperature in the ambient atmosphere furnace was increased to approximately 982° C. and the temperature was maintained for approximately 3 hours. The temperature in the ambient atmosphere furnace was then decreased to approximately 200° C. The laminate was removed from the ambient atmosphere furnace and allowed to cool to room temperature.

### Example 5

### Firing of the Cured Laminate Using a Modified Inert Firing Cycle

One of the pieces of the laminate (#4) was placed in an inert atmosphere furnace for firing. The inert atmosphere furnace was evacuated until the rate of pressure decrease slowed. When a pressure of 175 mTorr was achieved, the inert atmosphere furnace was purged with nitrogen. The evacuation and nitrogen purge were repeated. The temperature in the inert atmosphere furnace was increased to approximately 475° C. and maintained for approximately 1 hour. The temperature was increased to approximately 982° C. and maintained for approximately 3 hours. The temperature in the inert atmosphere furnace was then decreased to approximately 200° C. After the inert atmosphere furnace automatically evacuated and purged twice, the purge was disabled. The laminate was removed from the inert atmosphere furnace at a maximum of 200° C. and allowed to cool to room temperature.

### Example 6

### Physical Properties of the Fired Laminates

Each of the laminates was weighed and a thickness measured in nine locations, as shown in Table 1.

TABLE 1
Thicknesses of Laminates 1-4.

Laminate

| | 1 | 2 | 3 | 4 |
|---|---|---|---|---|
| Thickness 1 | 0.0325 | 0.0345 | 0.0330 | 0.0325 |
| (inches) | | | | |
| Thickness 2 | 0.0335 | 0.0340 | 0.0350 | 0.0345 |
| (inches) | | | | |
| Thickness 3 | 0.0330 | 0.0350 | 0.0350 | 0.0345 |
| (inches) | | | | |
| Thickness 4 | 0.0345 | 0.0350 | 0.0330 | 0.0335 |
| (inches) | | | | |
| Thickness 5 | 0.0335 | 0.0355 | 0.0350 | 0.0355 |
| (inches) | | | | |
| Thickness 6 | 0.0340 | 0.0345 | 0.0340 | 0.0345 |
| (inches) | | | | |
| Thickness 7 | 0.0345 | 0.0350 | 0.0335 | 0.0330 |
| (inches) | | | | |
| Thickness 8 | 0.0350 | 0.0350 | 0.0340 | 0.0350 |
| (inches) | | | | |
| Thickness 9 | 0.0355 | 0.0350 | 0.0340 | 0.0350 |
| (inches) | | | | |

Physical properties (fiber volume, matrix volume, porosity, and density) of each of the laminates were determined by conventional techniques and are shown in Table 2.

TABLE 2
Fiber Volume, Matrix Volume, Porosity,
and Density of Laminates 1-4.

Laminate

| | 1 | 2 | 3 | 4 |
|---|---|---|---|---|
| Vol % FAB | 45.8 | 44.8 | 45.8 | 45.5 |
| Vol % MAT | 28.5 | 28.8 | 29.1 | 29.1 |
| % Porosity | 25.7 | 26.4 | 25.0 | 25.4 |
| Density | 2.18 | 2.16 | 2.20 | 2.19 |

### Example 7

### Electrical Properties of the Fired Laminates

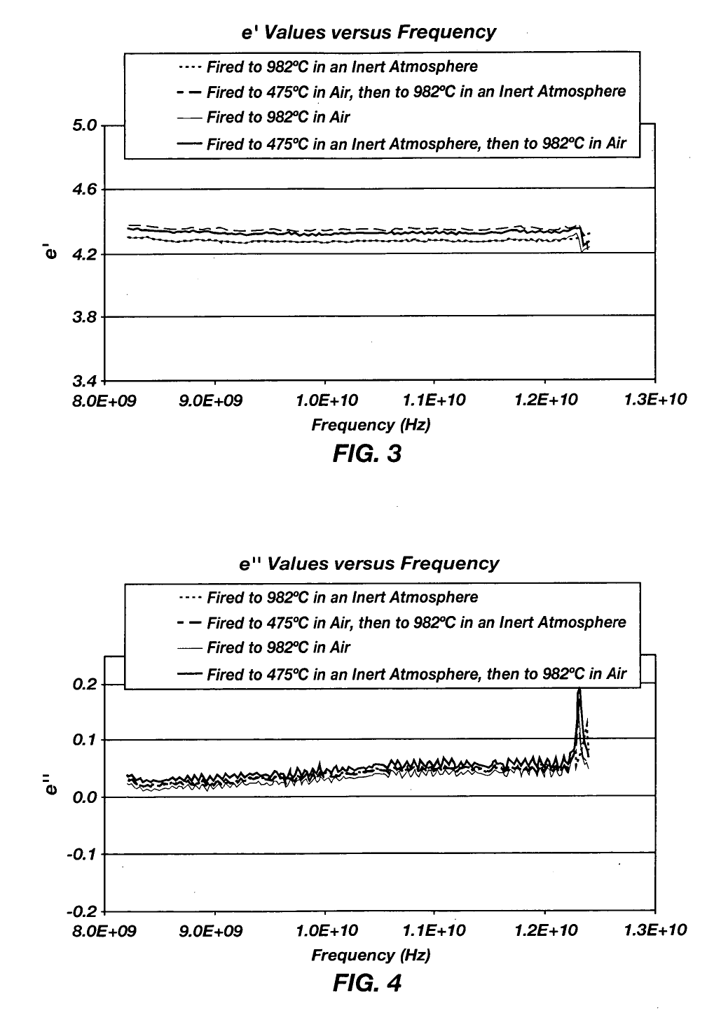

The dielectric response was determined by measuring e′ and e″ for each of the four laminates described above. Together, e′ and e″ describe the complex dielectric function of each of the laminates, which describes the behavior of an electric field in the samples of AS/N312HT-1 cured and fired under the various testing conditions. The data for e′ and e″ was generated by wave guide testing, which involves launching an electromagnetic wave at each of the laminates through a wave guide and measuring the electromagnetic wave that is reflected. Plots of the dielectric property (e′ or e″) versus frequency for each of the four laminates are shown in FIGS. 3 (e′ versus frequency) and 4 (e″ versus frequency). The plots show that firing the oxide CMC material that contains organic material in the inert atmosphere does not negatively affect the electrical properties of the fired structurally integrated component as there is no significant difference in the electrical properties of the laminates fired in the inert atmosphere compared to the laminates fired in air (ambient atmosphere). Analysis of the dielectric response of the laminates indicated that curing and firing the oxide CMC material under an inert atmosphere did not deleteriously affect the dielectric response of this material.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method of forming a structurally integrated component, comprising:
providing a first ceramic material comprising an oxidation sensitive ceramic material;
providing a second ceramic material comprising an uncured, oxide ceramic matrix composite;
contacting the second ceramic material and the first ceramic material to form an uncured, structurally integrated precursor component;
co-curing the uncured, structurally integrated precursor component to form a co-cured, structurally integrated precursor component; and
co-firing the co-cured, structurally integrated precursor component in an inert environment.

2. The method of claim 1, wherein providing a first ceramic material comprising an oxidation sensitive ceramic material comprises providing a first ceramic material that comprises oxide fibers and a carbon-based ceramic material selected from the group consisting of carbon fibers, carbon whiskers, carbon powder, graphite, silicon carbide, silicon oxycarbide, and mixtures thereof.

3. The method of claim 2, wherein providing a first ceramic material that comprises oxide fibers and a carbon-based ceramic material selected from the group consisting of carbon fibers, carbon whiskers, carbon powder, graphite, silicon carbide, silicon oxycarbide, and mixtures thereof comprises providing a first ceramic material that comprises oxide fibers selected from the group consisting of alumina, silica, aluminosilicate, aluminoborosilicate, and mixtures thereof and the carbon-based ceramic material.

4. The method of claim 2, wherein the first ceramic material further comprises at least one water-soluble organic ingredient selected from the group consisting of gum, vinyl alcohol, glycol, and mixtures thereof.

5. The method of claim 2, wherein the first ceramic material further comprises at least one water-soluble organic ingredient selected from the group consisting of methyl cellulose, acacia gum, propylene glycol, ethylene glycol, polyvinyl alcohol, and mixtures thereof.

6. The method of claim 1, wherein providing a first ceramic material comprising an oxidation sensitive ceramic material comprises providing a carbon-based, high-temperature, radar attenuating material.

7. The method of claim 1, wherein providing a first ceramic material comprising an oxidation sensitive ceramic material comprises providing a carbon-based, high-temperature, radar attenuating material that absorbs radio frequency energy in a range of from approximately 1 GHz to approximately 50 GHz.

8. The method of claim 1, wherein providing a second ceramic material comprising an uncured, oxide ceramic matrix composite comprises providing an inorganic oxide fiber reinforcement impregnated with an alumina matrix or an aluminosilicate matrix.

9. The method of claim 8, wherein providing an inorganic oxide fiber reinforcement impregnated with an alumina matrix or an aluminosilicate matrix comprises using alumina, a mixture of alumina and silicon dioxide, or a mixture of alumina, silicon dioxide, and boria as the inorganic oxide fiber reinforcement.

10. The method of claim 1, wherein co-curing the uncured, structurally integrated precursor component to form a co-cured, structurally integrated precursor component comprises exposing the uncured, structurally integrated precursor component to a temperature sufficient to cure the second ceramic material.

11. The method of claim 1, wherein co-curing the uncured, structurally integrated precursor component to form a co-cured, structurally integrated precursor component comprises co-curing the uncured, structurally integrated precursor component at a temperature ranging from approximately 75° C. to approximately 200° C.

12. The method of claim 1, wherein co-curing the uncured, structurally integrated precursor component to form a co-cured, structurally integrated precursor component comprises co-curing the uncured, structurally integrated precursor component in an inert atmosphere selected from the group consisting of nitrogen, argon, helium, and mixtures thereof.

13. The method of claim 1, wherein co-curing the uncured, structurally integrated precursor component to form a co-cured, structurally integrated precursor component comprises dehydrating and consolidating the second ceramic material around the first ceramic material.

14. The method of claim 1, wherein co-firing the co-cured, structurally integrated precursor component in an inert environment comprises exposing the co-cured, structurally integrated precursor component to a temperature sufficient to bond the first ceramic material and the second ceramic material.

15. The method of claim 1, wherein co-firing the co-cured, structurally integrated precursor component in an inert environment comprises co-firing the co-cured, structurally integrated precursor component in an inert atmosphere selected from the group consisting of nitrogen, argon, helium, and mixtures thereof.

16. The method of claim 1, wherein co-firing the co-cured, structurally integrated precursor component in an inert environment comprises co-firing the co-cured, structurally integrated precursor component at a temperature ranging from approximately 900° C. to approximately 1200° C.

17. The method of claim 1, wherein co-firing the co-cured, structurally integrated precursor component in an inert environment comprises co-firing the co-cured, structurally integrated precursor component at a temperature of approximately 982° C. wherein the first ceramic material comprises a carbon-based, high-temperature, radar attenuating material and the second ceramic material comprises an aluminosilicate matrix and a mixture of alumina, silicon dioxide, and boria as the inorganic oxide fiber reinforcement.

18. The method of claim 1, wherein co-firing the co-cured, structurally integrated precursor component in an inert environment comprises bonding the first ceramic material to the second ceramic material.

19. The method of claim 1, wherein co-firing the co-cured, structurally integrated precursor component in an inert environment comprises densifying and sintering the first ceramic material and the second ceramic material.

20. The method of claim 1, wherein co-firing the co-cured, structurally integrated precursor component in an inert environment comprises co-firing the co-cured, structurally integrated precursor component under conditions that preserve electrical properties of the first ceramic material and mechanical, electrical, and physical properties of the second ceramic material.

21. A co-cured, structurally integrated precursor component, comprising:
a first ceramic component comprising an oxidation sensitive ceramic material; and
a second ceramic component comprising an oxide ceramic matrix composite co-cured to the first ceramic component.

22. The co-cured, structurally integrated precursor component of claim 21, wherein the first ceramic component comprises oxide fibers and a carbon-based ceramic material selected from the group consisting of carbon fibers, carbon whiskers, carbon powder, graphite, silicon carbide, silicon oxycarbide, and mixtures thereof.

23. The co-cured, structurally integrated precursor component of claim 22, wherein the oxide fibers are selected from the group consisting of alumina, silica, aluminosilicate, aluminoborosilicate, and mixtures thereof.

24. The co-cured, structurally integrated precursor component of claim 21, wherein the first ceramic material further comprises at least one water-soluble organic ingredient selected from the group consisting of gum, vinyl alcohol, glycol, and mixtures thereof.

25. The co-cured, structurally integrated precursor component of claim 21, wherein the first ceramic material further comprises at least one water-soluble organic ingredient selected from the group consisting of methyl cellulose, acacia gum, propylene glycol, ethylene glycol, polyvinyl alcohol, and mixtures thereof.

26. The co-cured, structurally integrated precursor component of claim 21, wherein the first ceramic component comprises a carbon-based, high-temperature, radar attenuating material.

27. The co-cured, structurally integrated precursor component of claim 21, wherein the second ceramic component comprises an inorganic oxide fiber reinforcement impregnated with an alumina matrix or an aluminosilicate matrix.

28. The co-cured, structurally integrated precursor component of claim 27, wherein the inorganic oxide fiber reinforcement comprises a fiber reinforcement selected from the group consisting of alumina, a mixture of alumina and silicon dioxide, and a mixture of alumina, silicon dioxide, and boria.

29. A structurally integrated component, comprising:
a first ceramic component comprising an oxidation sensitive ceramic material; and
a second ceramic component comprising an oxide ceramic matrix composite bonded to the first ceramic component.

30. The structurally integrated component of claim 29, wherein the first ceramic component comprises oxide fibers and a carbon-based ceramic material selected from the group consisting of carbon fibers, carbon whiskers, carbon powder, graphite, silicon carbide, silicon oxycarbide, and mixtures thereof.

31. The structurally integrated component of claim 30, wherein the oxide fibers are selected from the group consisting of alumina, silica, aluminosilicate, aluminoborosilicate, and mixtures thereof.

32. The structurally integrated component of claim 29, wherein the first ceramic material further comprises at least one water-soluble organic ingredient selected from the group consisting of gum, vinyl alcohol, glycol, and mixtures thereof.

33. The structurally integrated component of claim 29, wherein the first ceramic material further comprises at least one water-soluble organic ingredient selected from the group consisting of methyl cellulose, acacia gum, propylene glycol, ethylene glycol, polyvinyl alcohol, and mixtures thereof.

34. The structurally integrated component of claim 29, wherein the first ceramic component comprises a carbon-based, high-temperature, radar attenuating material.

35. The structurally integrated component of claim 29, wherein the second ceramic material comprises an inorganic oxide fiber reinforcement impregnated with an alumina matrix or an aluminosilicate matrix.

36. The structurally integrated component of claim 35, wherein the inorganic oxide fiber reinforcement comprises a fiber reinforcement selected from the group consisting of alumina, a mixture of alumina and silicon dioxide, and a mixture of alumina, silicon dioxide, and boria.

37. The structurally integrated component of claim 29, wherein electrical properties of the first ceramic material and mechanical, electrical, and physical properties of the second ceramic material are substantially preserved.

38. The structurally integrated component of claim 29, wherein the second ceramic component is directly bonded to the first ceramic component.
